(19) United States
(12) Patent Application Publication
(10) Pub. No.: US 2006/0126838 A1
(43) Pub. Date: Jun. 15, 2006

(54) Method and system for facilitating communication

(76) Inventors: Avner Taieb, Petach tikva (IL); Florin Calin, Hod-hasharon (IL)

Correspondence Address: Eitan Law Group;c/o LandonIP, Inc.., Suite 450, 1700 Diagonal Road, Alexandria, VA, 22314, US

(21) Appl. No.: 11/007,299

(22) Filed: Dec. 9, 2004

(51) Int. Cl. H04N 7/167

(52) U.S. Cl. 380/229

(57) ABSTRACT

According to some embodiments of the present invention, two or more devices may establish an encrypted communication session by using a first set of directional transmitters, receivers and/or transceivers so as to transmit one or more unique identification strings over a first directional communication link. By deriving an encryption/decryption key set, at least partially based on the unique identification strings, the two or more devices may establish an encrypted communication session over a second communication link facilitated by a set of multi-directional transmitters, receivers and/or transceivers.

### FIELD OF THE INVENTION

The present invention generally relates to the field of communication. More specifically, the present invention relates to using a first set of directional transceivers to transmit one or more unique identification strings over a first directional communication link, and thereby enabling the initialization of an encrypted communication session over a second communication link using a set of multi-directional transceivers.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

In the ever evolving field of communications, new forms of media (e.g. sound, images, video, interactive multi-media content, etc.) are constantly being developed and improved. Most homes, business and various other locations in the developed world today have devices capable of receiving and displaying or playing content in various format and media types. More specifically, today's modern home, office, or home-office may contain at least one television, and mostly likely will also include a computer, a stereo, a DVD player, and a proprietary content provider's (e.g. cable or wireless content provider) decoder box. The terms “Home Theater”, “Home Entertainment Center” or “Media Center” have been coined to designate a set of devices or even complex media presentation systems for the presentation of content to persons within a home or office. With the continual evolution of the various media types in which content is being delivered, the devices and systems used receive and present that content is also evolving and growing in number.

As the number and complexity of devices and systems used is growing, so is the need to interconnect these devices. Since many devices need to be connected with other devices in order to function fully and properly (e.g. a DVD player needs to be connected to a Video Display and to an Audio Output System), the need for means to establish efficient connections or networks of connections between various home devices and systems is growing. Since modern communication devices and networks today are best characterized by features such as high bandwidth/data-rate, complex communication protocols, various transmission medium, and various access means, solutions for interconnecting media related devices and systems to date have typically centered around wiring the devices to one another using various cables of various configurations and sizes. For example, fiber optic cables, which are used as part of data networks spanning much of the world's surface, are sometimes used to connect the audio output of CD or DVD to an Audio System.

More recently, wireless (i.e. Radio Frequency) transceivers, protocols and networks (Bluetooth, WiFi, WiFi-Max, etc.) have been used to interconnect various devices in the home and office. Although wireless interconnection of devices is typically easier and cleaner to implement than using wiring which needs to be installed and placed so as not to be intrusive and/or unaesthetic, with the use of wireless transceivers for interconnection of device, security of the data being transmitted between device becomes an issue. Due to the ease by which wireless transmissions may be intercepted, there is at times a need for encryption of the data transmitted between devices via a wireless data link.

### SUMMARY OF THE INVENTION

There is provided, in accordance with some embodiments of the present invention, a method and a system for enabling at least a first communication device and a second communication device to establish encrypted communication. According to some embodiments of the present invention, the first device may establish a first directional communication link with the second device using directional (e.g. Infrared) transmitters, receivers and/or transceivers on both devices. In accordance with some embodiments of the present invention, the first device may be adapted to establish the first communication link with the second device upon sensing the second device, upon receiving a signal from the second device, or upon receiving a user command or signal. The first device, over the first directional communication link, may obtain from the second device a unique identification string (“ID string”) associated with the second device. According to some embodiments of the present invention, the second device may also receive from the first device an ID string associated with the first device.

In accordance with some embodiments of the present invention, the first device may transmit data to the second device over a second communication link established using multidirectional (e.g. Radio Frequency) transceivers on both devices. It should be understood by those versed in the communication arts that the terms directional and multi-directional may be relative in nature. For example, an Infrared (“IR”) transmitter producing a circular cone of transmission having an angle of 10 degrees may be considered directional with respect to a Radio Frequency transmitter which transmits a signal through an antenna which produces one or lobes of transmission having a cumulative radiation angle of over 30 degrees. Although in the above example, the Infrared transmitter may produce a fairly spread out cone of transmission, since the IR cone of transmission is far smaller than that of the RF transmitter, the IR transmitter may be considered a directional transmitter relative to the RF transmitter, and the RF transmitter may be considered a multi-directional transmitter relative to the IR transmitter.

As part of establishing an encrypted communication session over the second communication link, according to some embodiments of the present invention, either device may transmit an encryption control signal to the other device over the second communication link, indicating a procedure for generating encryption and/or decryption keys based on the one or more ID strings transmitted and/or exchanged by the first and second devices over the first communication link. According to other embodiments of the present invention, the one or more ID strings may be the actual encryption/decryption key(s), or encryption/decryption key(s) may be generated by both devices based on the ID strings using a predefined algorithm which both devices already know. According to some embodiments of the present invention, encryption/decryption key(s) may be generated by both devices based on the ID strings using a predefined algorithm which takes into account the ID string(s) and the output of substantially synchronized timers on each of the devices.

According to some embodiments of the present invention, based on the one or more ID strings transmitted and/or exchanged over the first communication link, and possibly based on an encryption control signal, the first and second devices may generate matching or corresponding encryption and/or decryption keys. According to some further embodiments of the present invention, the first and second devices may establish one or more encrypted communication sessions, one session in each direction, using their respective multidirectional transmitters, receivers and/or transceivers and the encryption/decryption keys.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustration of the steps of a method of enabling and establishing encrypted communication between two devices, in accordance with some embodiments of the present invention;

FIGS. 2A-2C are block diagrams illustrating two devices establishing an encrypted communication session in accordance with the steps of the flow chart in FIG. 1, and in accordance with various embodiments of the present invention;

FIG. 3 is a flowchart illustration of the step of a method of “initializing an encrypted data transmission session” (step 2000 in FIG. 1), according to some embodiments of the present invention;

FIG. 4 is a block diagram illustrations of two devices, a paired transmitter and receiver, according to some embodiments of the present invention; and

FIG. 5 is a block diagram of a specific exemplary embodiment of the present invention adapted for use with a Digital Video Device (“DVD”) and a video monitor.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

There is provided, in accordance with some embodiments of the present invention, a method and a system for enabling at least a first communication device and a second communication device to establish encrypted communication. According to some embodiments of the present invention, the first device may establish a first directional communication link with the second device using directional (e.g. Infrared) transmitters, receivers and/or transceivers on both devices. In accordance with some embodiments of the present invention, the first device may be adapted to establish the first communication link with the second device upon sensing the second device, upon receiving a signal from the second device, or upon receiving a user command or signal. The first device, over the first directional communication link, may obtain from the second device a unique identification string (“ID string”) associated with the second device. According to some embodiments of the present invention, the second device may also receive from the first device an ID string associated with the first device.

In accordance with some embodiments of the present invention, the first device may transmit data to the second device over a second communication link established using multidirectional (e.g. Radio Frequency) transceivers on both devices. It should be understood by those versed in the communication arts that the terms directional and multi-directional may be relative in nature. For example, an Infrared (“IR”) transmitter producing a circular cone of transmission having an angle of 10 degrees may be considered directional with respect to a Radio Frequency transmitter which transmits a signal through an antenna which produces one or lobes of transmission having a cumulative radiation angle of over 30 degrees. Although in the above example, the Infrared transmitter may produce a fairly spread out cone of transmission, since the IR cone of transmission is far smaller than that of the RF transmitter, the IR transmitter may be considered a directional transmitter relative to the RF transmitter, and the RF transmitter may be considered a multi-directional transmitter relative to the IR transmitter.

As part of establishing an encrypted communication session over the second communication link, according to some embodiments of the present invention, either device may transmit an encryption control signal to the other device over the second communication link, indicating a procedure for generating encryption and/or decryption keys based on the one or more ID strings transmitted and/or exchanged by the first and second devices over the first communication link. According to other embodiments of the present invention, the one or more ID strings may be the actual encryption/decryption key(s), or encryption/decryption key(s) may be generated by both devices based on the ID strings using a predefined algorithm which both devices already know. According to some embodiments of the present invention, encryption/decryption key(s) may be generated by both devices based on the ID strings using a predefined algorithm which takes into account the ID string(s) and the output of substantially synchronized timers on each of the devices.

According to some embodiments of the present invention, based on the one or more ID strings transmitted and/or exchanged over the first communication link, and possibly based on an encryption control signal, the first and second devices may generate matching or corresponding encryption and/or decryption keys. According to some further embodiments of the present invention, the first and second devices may establish one or more encrypted communication sessions, one session in each direction, using their respective multidirectional transmitters, receivers and/or transceivers and the encryption/decryption keys.

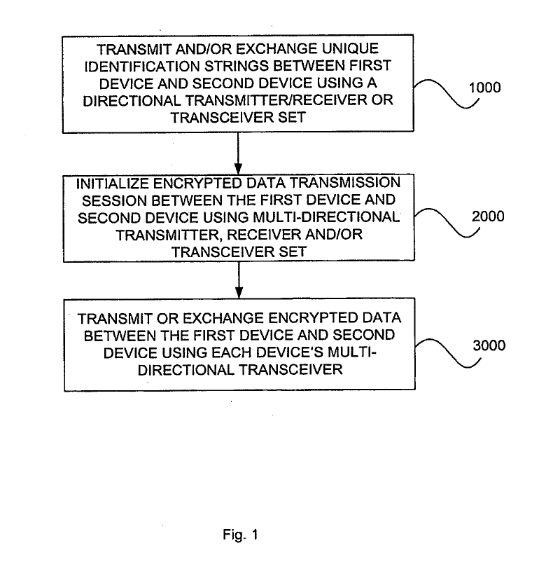

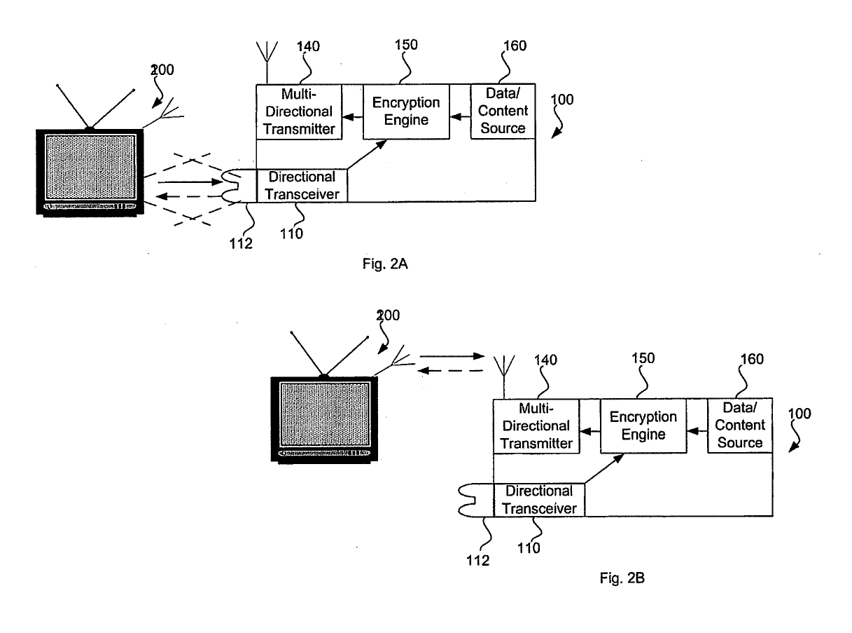

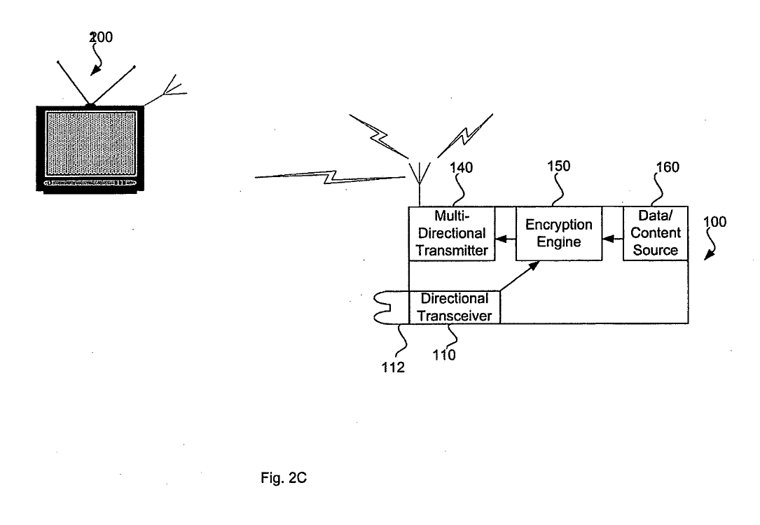

Turning now to FIG. 1, there is shown a flowchart illustration of the steps of a method of enabling and establishing encrypted communication between two devices, in accordance with some embodiments of the present invention. As shown in FIG. 2A, which corresponds to step 1000 of FIG. 1, a first device 100 may communicate with a second device 200 via a data link established using a directional transmitter and receiver, or a directional transceiver 110 on both devices. During this phase, either device may transmit a unique identification string or code associated with the transmitting device, and in accordance with some embodiments of the present invention, both devices may transmit their respective unique identification strings to the other device.

According to some embodiments of the present invention, the directional transmitter/receiver set and/or transceiver set may be optical, or an infrared optical. Each of these types of transmitters, receivers and transceivers, their use and their operational characteristics, are well known in the communication arts. Any transceivers having directional lobes of transmission and reception, known today or to be devised in the future, may be applicable to the present invention.

According to some embodiments of the present invention, the identification string transmitted by a first device to another device (step 1000) over a directional link may be fixed. However, according to other embodiments of the present invention, each time a device prepares to transmit a unique string to another device (step 1000), the transmitting device may generate a new unique string, may index and store a copy of the new string which it generated, and may transmit the new unique string to the other device. According to further embodiments of the present invention, a first device may transmit to a second device a fixed unique identification string which the first device transmits to all devices with which it exchanges unique identification strings, while the second device may respond to the receipt of the fixed unique identification string by generating a new string and transmitting the new string to the first device. Any combination of fixed and/or dynamically generated identification codes or strings may be applicable to the present invention.

As shown in FIG. 2B, which corresponds to step 2000 of FIG. 1, once either of the two devices 100 or 200 has a copy of one or more unique identification string which the other device also knows, e.g., both devices know the same unique string and are both able to refer or to identify the string by an index number or value, the two devices may generate a pair of corresponding encryption and decryption keys which may be used to facilitate an encrypted data session between the two devices 100 and 200.

According to some embodiments of the present invention, the transmitted or exchanged ID string(s) may act as an encryption/decryption key. According to further embodiments of the present invention, the transmitted or exchanged ID string(s) may act as the basis of an encryption/decryption key set, derived from the ID string using an algorithm known to both devices 100 and 200.

In those cases where an encryption/decryption key set is derived from the ID string(s) using some algorithm, the algorithm (1) may be fixed and known by both devices, (2) may be selected by both devices based on a timer related scheme where the output of corresponding timers in each of the devices is used as the basis for selecting a specific algorithm, or (3) may be selected by one device and the selection may be transmitted to the second device. According to some embodiments of the present invention, one of the two devices may select a specific algorithm with which to derive an encryption/decryption key set from the one or more identification strings the first and second devices both know, and the device which has selected the algorithm may transmit to the other device an instruction signal (e.g. encryption control signal) including the algorithm used and an indicator as to which commonly known identification strings the algorithm was applied. According to some embodiments of the present invention, an encryption/decryption key set may be derived from only one commonly known identification string, or according to other embodiments may be derived from some combination of two or more commonly known strings.

According to further embodiments of the present invention, the encryption control signal may contain instructions relating to the generation of a decryption key and not on the generation of an encryption key. A first device may select a specific algorithm by which to transform a data string, commonly known with a second device, in order to produce a key with which the first device intends to encrypt data to be transmitted to a second device. The first device may send a signal to the second device indicating (1) some code, index or reference number associated with the commonly known strings that were used to generate the encryption key, and (2) instructions on how to transform the commonly known string into a decryption key. The field of encryption and decryption is well known and any methodology, known today or to be devised in the future, relating to the generation of encryption and/decryption keys based on commonly known data strings may be applicable to the present invention.

According to some embodiments of the present invention, one device may transmit an encryption control code to a second device via a multidirectional communication link established using multidirectional transceivers 140. It will be clear to one of ordinary skill in the communication arts that the present invention is not limited to encrypted communication between only two devices. Any device produced according to various embodiments of the present invention may participate in steps 1000 and 2000 with any countless number of other devices produced in accordance the present invention.

Turning now to FIG. 2C, which corresponds with step 3000 of FIG. 1, there is shown an example of encrypted transmission, using multidirectional transceivers (e.g. Radio Frequency transceivers) from transmitter 100 to receiver 200, once both devices have generated corresponding encryption and decryptions keys in accordance with steps 1000 and 2000. According to some embodiments of the present invention, the transmitter may transmit to several receivers simultaneously by encrypting the data using an encryption key which has multiple decryption keys, where each of the receiving devices has generated at least one such decryption key based on a process and method in accordance with some embodiments of the present invention.

According to further embodiments of the present invention, there may be bidirectional communication between any two devices. For example, the multidirectional transmission may be in accordance with a wireless data transmission/networking standard such as WiFi, and any transmission of data from a first device to second device may require a control signal from the second to the first indicating receipt of the transmitted data. According to some embodiments of the present invention, a single encryption/decryption key set may be generated for both directions. However, according to other embodiments, a separate key pair may be generated for each direction. According to some embodiments of the present invention, each device which may transmit encrypted data to a second device may transmit an encryption control signal to the device which will is the intended recipient of the encrypted data. In other situations, a device which is to be the recipient of encrypted data may send an encryption control signal to the transmitting device instructing the transmitted device how to generate an encryption key.

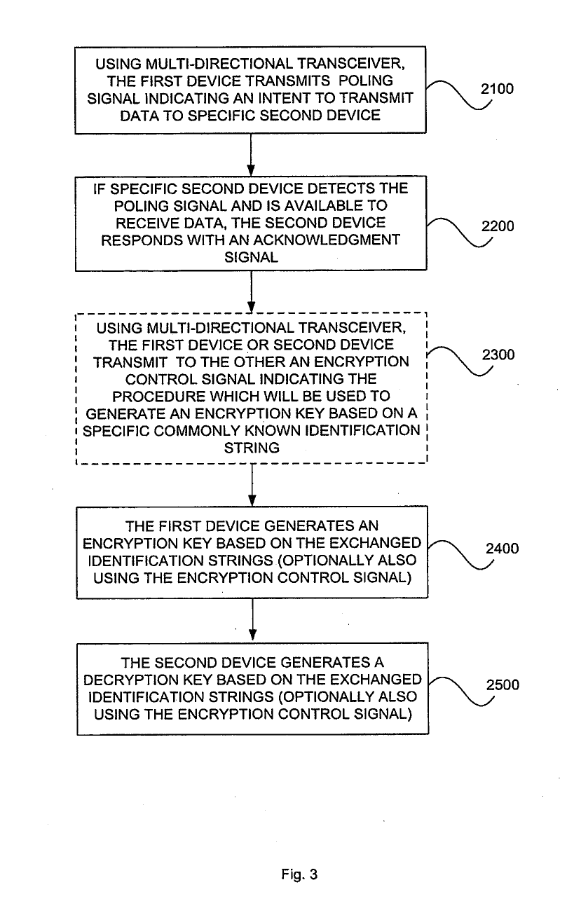

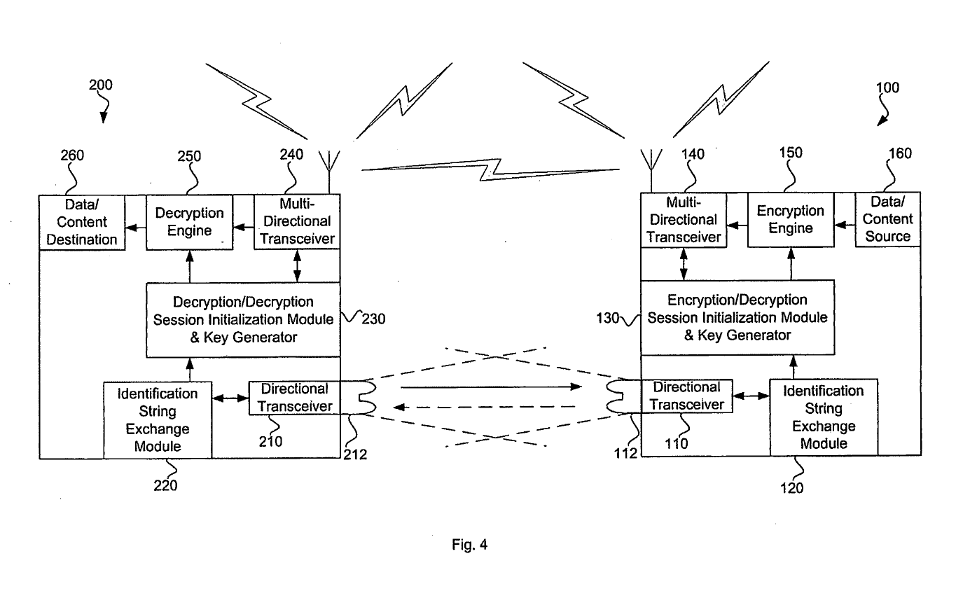

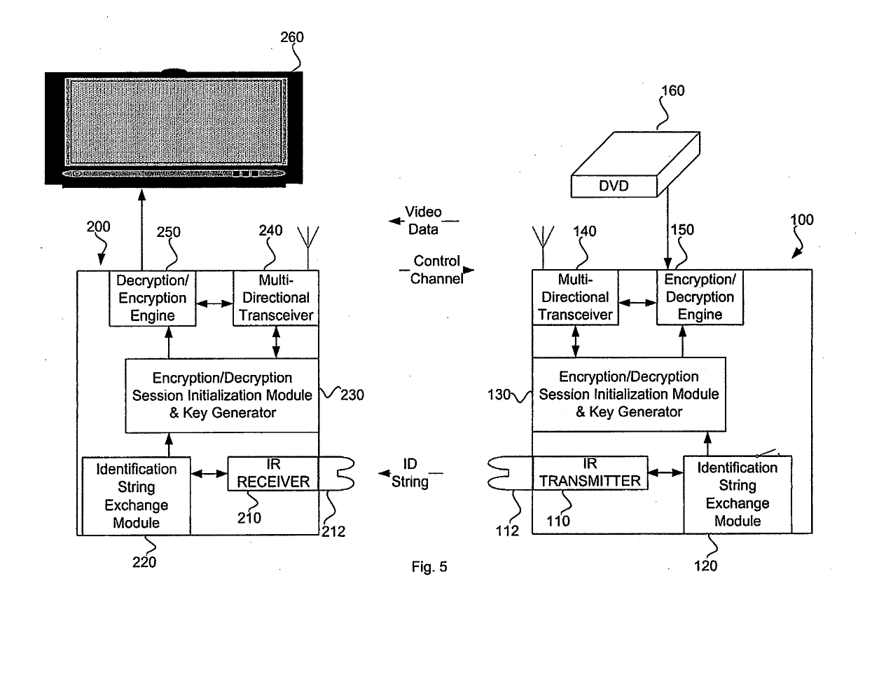

Turning now to FIG. 3, there is shown a flow chart illustration of the steps of a method of “initializing an encrypted data transmission session” (step 2000 in FIG. 1), according to some embodiments of the present invention. FIG. 3 may be examined in conjunction with FIG. 4, which is a block diagram illustrations of two devices, a paired transmitter and receiver, according to some embodiments of the present invention. Directional transceiver 110 and 210, on the transmitter 100 and receiver 200 respectively, may be optical infrared transceivers and may include optical transceiver domes, 112 and 212 respectively. Either device's identification string exchange module 120 and 220, respectively, may transmit to the other device a unique identification string associated with and/or known by the transmitting device. Along with transmitting the actual identification string, the transmitting device may also transmit an indexing or reference string associated with the specific string, such that both devices may know both the given unique identification string and the given ID string's associated indexing or reference string/value.

When a first device, for example the transmitter 100, intends to transmit encrypted data to a second device, for example the receiver 200, the encryption session initialization module 130 on the first device may cause a poling signal to be transmitted through a multidirectional transceiver 140 to the receiver 200 (step 2100). The decryption session initialization module 230 may be forwarded the poling signal which was received by the receiver's 200 multidirectional receiver 240, and the session initialization module 230 may acknowledge the signal (step 2200). Optionally, either the transmitter's session initialization module 130 or the receiver's session initialization module 230 may select a commonly known identification string, exchanged as part of step 1000 in FIG. 1, and a key generation procedure for the production of an encryption/decryption key set. The selecting device may transmit an encryption control signal (step 2300), indicating which string and what procedure was selected, to the other device. As mentioned above, sometimes the control signal may only contain instructions as to how an encryption or decryption key is to be generated, while according to other embodiments, the encryption control signal may indicate how both the encryption and decryption key may be generated.

The transmitter's 100 key generator 130 may generate an encryption key in accordance with the ID string(s) and optionally with the selected encryption control signal (step 2400), and the receiver's 200 key generator may generate a corresponding decryption key in accordance with the ID string(s) and optionally with the selected control signal (step 2500). Once the encryption key has been loaded into the transmitter's encryption engine 150, and the decryption key has been loaded into the receiver's decryption engine 250, the transmitter may begin transmitting encrypted data to the receiver 200 via their respective multidirectional transceivers (FIG. 1—step 3000). As mentioned above, encrypted transmission of data between devices may be bidirectional. Thus, the key generator 230 on the receiver 200 may also generate an encryption key with which to encode and transmit data to the transmitter 100. Conversely, the key generator 130 on the transmitter 100 may also generate a decryption key to decrypt data received from the receiver 200. Furthermore, the identification string exchange module 120 may include a button or switch which a user may press in order to cause the module 120 to activate.

Turning now to FIG. 5, there is shown a specific embodiment of the present invention, wherein the first device only has a directional transmitter and the second device only has a directional receiver, and thus an ID string may only be transmitted from the first device 100 to the second device 200. Based on the transmitted ID string, both devices may generate encryption/decryption key sets, and may engage in bidirectional communication using their respective multidirectional transceivers 140 and 240. According to the example shown in FIG. 5, the first device 100 may transmit to the second device 200 video data from a Digital Video Device (“DVD”) and the second device 200 may send to the first device 100 signal control information relating to the receipt of the video data.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of enabling at least a first communication device and a second communication device to establish an encrypted communication session, comprising:
a. over a first directional communication link, a first device receiving from a second device a unique identification string associated with the second device; and
b. transmitting data between the two devices using a second multidirectional communication link, wherein data transmitted over the second communication link is encrypted and decrypted using one or more keys derived from the unique identification string.

2. The method according to claim 1, wherein each of the two devices receives a unique identification code of the other device.

3. The method according to claim 1, wherein receiving a unique identification string comprises bringing an infrared transmitter on the first communication device and a corresponding receiver on the second communication device within operational range of one another.

4. The method according to claim 3, wherein said receiving said unique identification sting further comprises initiating a data transfer session between the two devices using the directional transceivers.

5. The method according to claim 4, further comprising sending an encryption control signal from one device to another device.

6. The method according to claim 5, wherein the encryption control signal indicates a procedure for generating encryption and/or decryption keys using one unique identification string.

7. The method according to claim 6, wherein the encryption control signal indicates a procedure for generating encryption and/or decryption keys using both unique identification strings.

8. An encrypted data transmitter comprising:
a. a directional transmitter adapted to transmit to another device a unique identification string associated with said transmitter; and
b a multidirectional transmitter adapted to transmit data received from an encryption engine, wherein said encryption engine uses an encryption key derived at least partially from the transmitted unique identification string.

9. The transmitter according to claim 8, wherein said directional transmitter is also a directional receiver (“transceiver”).

10. The transmitter according to claim 9, wherein said directional transceiver is selected from the group consisting of optical transceivers, acoustic transceivers and infrared optical transceivers.

11. The transmitter according to claim 9, wherein said directional transceiver is adapted to receive a unique identification string associated with the other device.

12. The transmitter according to claim 8 wherein said multidirectional transmitter is also a multidirectional receiver (“transceiver”).

13. The transmitter according to claim 12, where an encryption control signal is either transmitted to or received from the other device via said multidirectional transceiver.

14. The transmitter according to claim 13, further comprising an encryption session initialization module adapted to either generate or to received an encryption control signal.

15. The transmitter according to claim 14, wherein said directional transmitter is also a directional receiver (“transceiver”).

16. The transmitter according to claim 15, wherein said directional transceiver is adapted to receive a unique identification string associated with the other device.

17. The transmitter according to claim 16, further comprising an encryption key generator adapted to generate an encryption key based on the encryption control signal and on the unique identification string associated with said transmitter and/or with the unique identification string received by said directional transceiver.

18. The transmitter according to claim 17, wherein said encryption engine uses an encryption key generated by said encryption key generator.

19. An encrypted data receiver comprising:
a. a directional transmitter adapted to transmit a unique identification string associated with said receiver;
b. a multidirectional receiver adapted to receive encrypted data from the other device; and
c. a decryption engine adapted to decrypt the received encrypted data using a key at least partially derived from the transmitted unique identification string.

20. The receiver according to claim 19, wherein said directional transmitter is also a directional receiver (“transceiver”).

21. The receiver according to claim 20, wherein said directional transceiver is selected from the group consisting of optical transceivers, acoustic transceivers and infrared optical transceivers.

22. The receiver according to claim 21, wherein said directional transceiver is adapted to receive a unique identification string associated with the other device.

23. The receiver according to claim 19, wherein said multidirectional receiver is also a multidirectional transmitter (“transceiver”).

24. The receiver according to claim 23, where an encryption control signal is either transmitted to or received from the other device via said multidirectional transceiver.

25. The receiver according to claim 24, further comprising a decryption session initialization module adapted to either generate or to receive an encryption control signal.

26. The receiver according to claim 25, wherein said directional transmitter is also a directional receiver (“transceiver”).

27. The receiver according to claim 26, wherein said directional transceiver is adapted to receive a unique identification string associated with the other device.

28. The receiver according to claim 27, further comprising a decryption key generator adapted to generate an decryption key based on the encryption control signal and on the unique identification string associated with said transmitter and/or with the unique identification string received by said directional transceiver.

29. The receiver according to claim 28, wherein said decryption engine uses a decryption key generated by said decryption key generator.
